(19) United States
(12) Patent Application Publication
(10) Pub. No.: US 2005/0125492 A1
(43) Pub. Date: Jun. 9, 2005

(54) Integrated network element management system and method

(76) Inventors: Hung-Ping Yu, Tu-Chen (TW); Jay Wang, Tu-Chen (TW); Chen Yu Chen, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/839,627

(22) Filed: May 4, 2004

(30) Foreign Application Priority Data
Dec. 5, 2003 (TW) 92134333

(51) Int. Cl. G06F 15/16

(52) U.S. Cl. 709/203

(57) ABSTRACT

An integrated network element management system includes a client computer (6) and a master network element (7). The client computer includes a user interface (61) and an application (62). Various network elements may be displayed on the user interface in the form of icons that can be dragged by a user. The application performs configuration on a specific network element selected by the user on the user interface. The master network element communicatively connects with the client computer and a plurality of network elements. The master network element includes a topology information module for collecting topology information via the Topology Discovery Protocol, and for storing the topology information and configuration files of the network elements. A related integrated network element management method is also provided.

### BACKGROUND OF THE INVENTION

1. Field of the Invention

The present invention relates to network management systems and methods, and particularly to integrated network element management systems and methods.

2. Background of the Invention

With the rapid development and widespread application of electronic communications networks, more and more people are employing networks for business services and information exchange. The safe and smooth operation of a typical network relies on the provision of different services by various web servers. The services comprise browsing of web pages, transmission of File Transfer Protocol (FTP) files, discussion of news, dynamic configurations of Internet Protocol (IP) addresses, and so on.

Driven by demand for the above-mentioned applications, networks are being developed in almost every corner of the globe. How to effectively manage and configure various devices (“elements”) connected on these networks is becoming an increasingly important and demanding task for network managers. A conventional means is shown in FIG. 4. Network managers configure network elements 5 in each of network segments 3 of a network 4 using a management computer 2 that accompanies the network elements 5 of each network segment 3. The network managers can also configure the network elements 5 one by one via a remote control computer 1. These configuration means are limited by the geographic distribution of the network segments 3, and are tedious and inefficient.

Recently developed technologies enable network elements geographically distributed in different locations to be schematically displayed in a diagram. Network managers at a central location can configure the network elements using the diagram. For instance, U.S. Pat. No. 6,347,336 issued on Feb. 12, 2002 discloses an automatic discovery and positioning method for network elements in a network management system, for the purposes of configuring the topology of the network. By using a graphic user interface screen, a network operator provides subscribers the service of automatically discovering the configuration management and network topology of optical network units in a fiber loop carrier-curb (FLC-C) system. When a host digital terminal or optical network unit connected to a subscriber is added to a fiber loop carrier-curb management system, the added network element is displayed on the graphic user interface screen as a new icon in a designated position of the network topology. Conversely, when a network element is removed from the management system, its corresponding icon is deleted from the network topology.

Similarly, China Patent Publication No. CN1287736A published on Mar. 14, 2001 discloses a home-network auto-configuration system and method. As shown in FIG. 5, two personal computers (102, 104) in a network (100) are automatically configured in order to share respective resources (108, 110, 112, 114; 116, 118, 120, 122) registered at the respective individual personal computers (102, 104). Services and resources (108, 110, 112, 114; 116, 118, 120, 122) local to one of the personal computers (say, 102) are registered with the other personal computer (say, 104), and vice versa. The respective registry (124, 126) hides whether a service or resource is local or remote. In operational use of the network (100), a resource or service local to one personal computer (say, 102) is addressable for the remote personal computer (say, 104) as if the resource or service were local to the remote personal computer (say, 104). A home network of personal computers is configured automatically in this manner.

China Patent Publication No. CN1322356A published on Nov. 14, 2001 discloses a device discovery and configuration method and system in a home network. As shown in FIG. 6, the system provides the capability for discovering and configuring one or more network devices connected to the home network, and for independently generating different user interface (UI) descriptions of the network devices connected to the home network for user command and control. A UI description of a network device is generated independently by the network device itself. Generating a UI in each network device rather than generating a central UI allows a network device to show its own device icon/text preferentially in the UI.

The above-described systems and methods are mostly based on private application environments, such as the FLC-C system and the home network. Thus network elements in the systems can be fully supported. However, different networks have their respective different configuration environments, and it is problematic to integrate such networks. There is no known system or method that allows network managers to not only centrally manage network elements distributed in different locations, but also integrate the network elements in a management system for configuration thereof.

### SUMMARY OF THE INVENTION

Accordingly, an objective of the present invention is to provide an integrated network element management system for configuring various network elements on a network.

Another objective of the present invention is to provide a integrated network element management method for configuring various network elements on a network.

In order to accomplish the above-mentioned first objective, a preferred integrated network element management system for configuring various network elements on a network comprises a client computer and a master network element. The client computer comprises a user interface for displaying a topology of the network, and an application for performing configurations on the network element. Each network element is displayed in the topology in the form of an icon. Each icon is draggable using a computer mouse. The master network element is communicatively connected to the client computer and the network elements, and communicates with the network elements via the Topology Discovery Protocol (TDP) for obtaining information on the topology of the network. The master network element comprises a topology information module for collecting and storing the information on the topology of the network, and for storing configuration files of the network elements. When an icon representing one network element is dragged to icons representing other network elements, a configuration file of said one network element is transmitted to said other network elements.

In order to accomplish the above-mentioned second objective, a preferred integrated network element management method for configuring various network elements on a network comprises the steps of: (i) obtaining a topology of the network, and displaying the topology on a user interface, the network elements being represented with icons in the topology; (ii) selecting a specific network element from the topology on the user interface, and configuring the specific network; (iii) storing configuration results in a configuration file of the specific network; (iv) determining whether there is another network element needing to be configured; (v) if there is another network element needing to be configured, dragging the icon representing the specific network element to the icon representing the another network element, whereby the configuration file of the specific network element is transmitted to said another network element; and (vi) said another network element automatically self-configuring based on the configuration file of the specific network element.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a block diagram of an application environment of an integrated network element management system in accordance with the preferred embodiment of the present invention;

FIG. 2 is a schematic diagram of a software infrastructure of the integrated network element management system in accordance with the preferred embodiment of the present invention;

FIG. 3 is a flow chart of an integrated network element management method in accordance with the preferred embodiment of the present invention;

FIG. 4 is a block diagram of an application environment of a conventional network element management system;

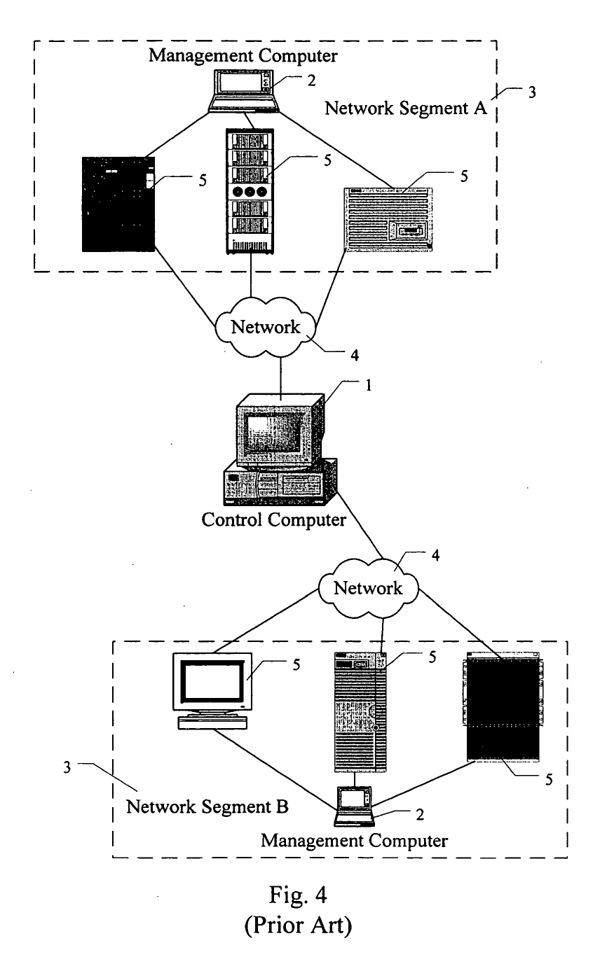

FIG. 5 is a block diagram of a conventional home-network auto-configuration system; and

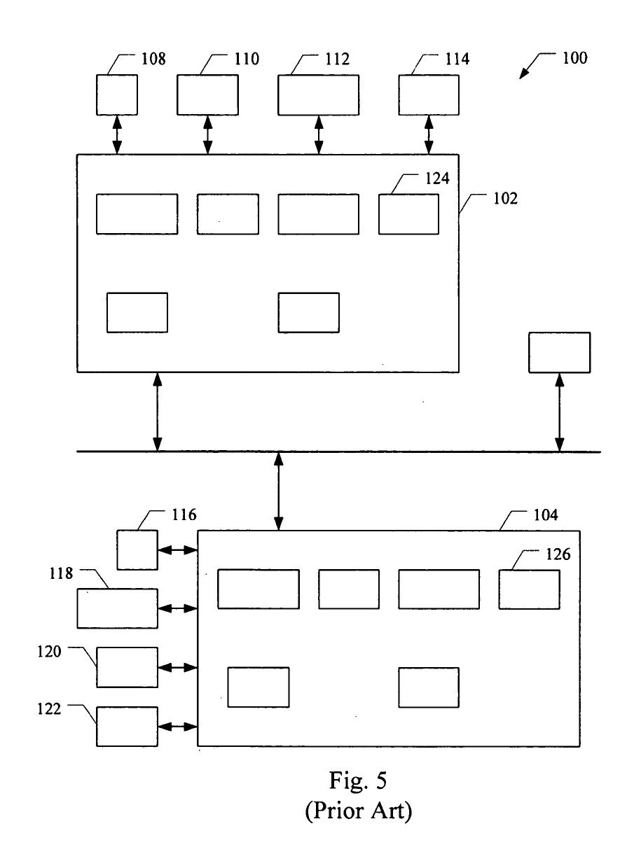

FIG. 6 is a block diagram of a conventional device discovery and configuration method and system in a home network.

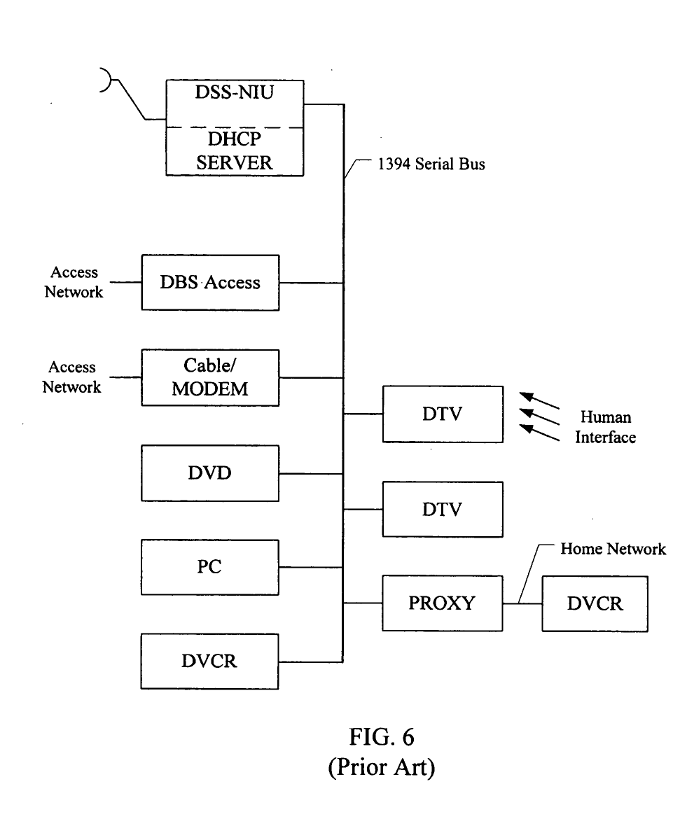

### DETAILED DESCRIPTION OF PREFERRED EMBODIMENTS OF THE INVENTION

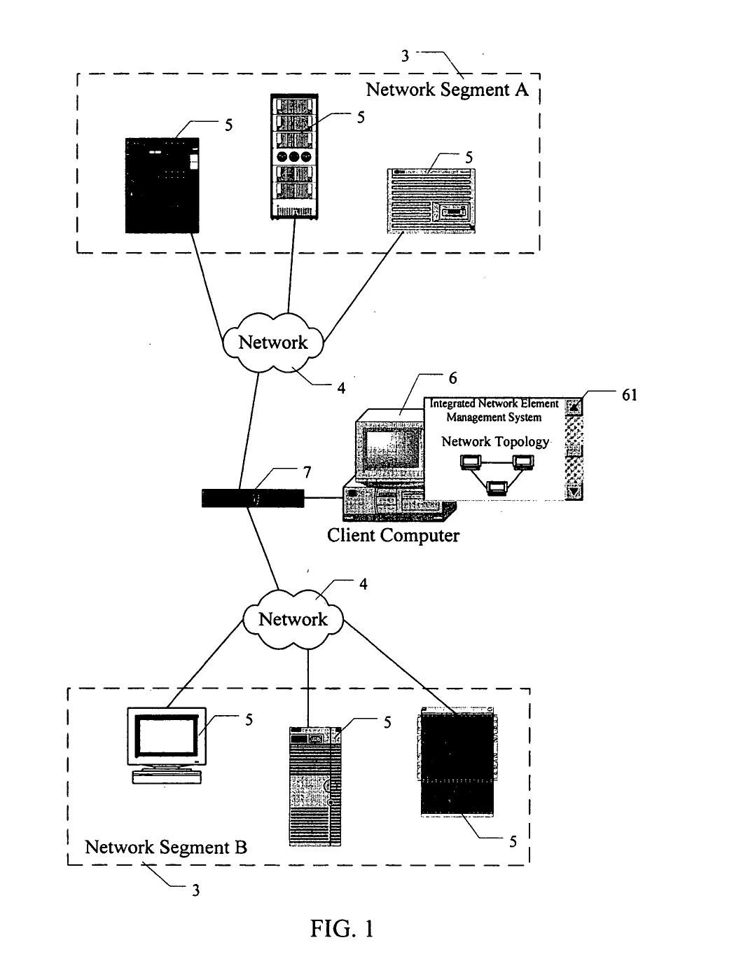

FIG. 1 is a schematic diagram of an application environment of an integrated network element management system in accordance with the preferred embodiment of the present invention. In the application environment, a client computer 6 is communicatively connected to a plurality of network segments 3 on a network 4 via a master network element 7. Each network segment 3 comprises a plurality of network elements 5. The network elements 5 may be routers, switches, remote computers, and so on. The client computer 6 provides a user interface 61. In the preferred embodiment, a Topology Discovery Protocol (TDP) is employed for discovering network elements 5 on the network 4, and for obtaining information on the network elements 5. Discovered network elements 5 and connections thereof form a so-called topology of the network 4. The topology can be displayed on the user interface 61. Each network element 5 in the topology is represented by an individual icon. Via the topology shown in the user interface 61, a network manager may obtain information on connections of the network elements 5. Furthermore, when a new network element 5 is connected to the network 4, an icon representing the new network element 5 is added to the topology. In contrast, when an existing network element 5 is removed, the icon representing the existing network element 5 is deleted from the topology.

The master network element 7 is provided for collecting information on the topology by way of sending requests to and receiving responses from all the network elements 5 on the network 4. In the preferred embodiment, the master network element 7 is a switch. When receiving the requests sent from the master network element 7, each network element 5 sends a response to the master network element 7, the response comprising information on the topology collected by the network element 5. The master network element 7 gathers and integrates information on the topology collected by all the network elements 5. When a network manager sends a request for the topology of the network 4 via the client computer 6, the master network element 7 sends the information on the topology to the client computer 6. Through the user interface 61, the network manager can browse the topology of the network 4.

In the preferred embodiment, by performing operations on icons representing various network elements 5, the network manager can perform configurations on corresponding network elements 5. For instance, when the network manager double-clicks on an icon in the topology with a mouse, a configuration file of a network element 5 represented by the icon is opened. The configuration file comprises demanded applications and files for configuration of the network element 5. By performing operations on the configuration file, the network manager can attain the desired configuration of the corresponding network element 5.

Once the network element 5 is configured, generated configuration results are stored in the configuration file of the network element 5. Through the user interface 61, the network manager may copy the configuration file comprising the configuration results to configuration files of other network elements 5 that have not been configured. Based on the configuration file comprising the configuration results, the other network elements 5 automatically perform self-configuration. Thus, the network manager need not configure the other network elements 5 one by one. Accordingly, the efficiency of configuring the network elements 5 is improved.

In an alternative embodiment of the present invention, the Network Neighborhood in a Microsoft Windows operating system is employed for discovering the network elements 5 and the topology of the network 4. The Network Neighborhood is used for transmitting files between personal computers. By using the Network Neighborhood, the network elements 5 can be automatically discovered and displayed. Once the network manager has finished configuring a specific network element 5, the network manager uses the mouse to drag an icon representing the specific network element 5 to other icons respectively representing other network elements 5. By this means, a configuration file of the specific network element 5 is automatically copied to configuration files of the other network elements 5 via a suitable network protocol such as File Transfer Protocol (FTP). The other network elements 5 automatically self-configure based on the configuration file of the specific network element 5.

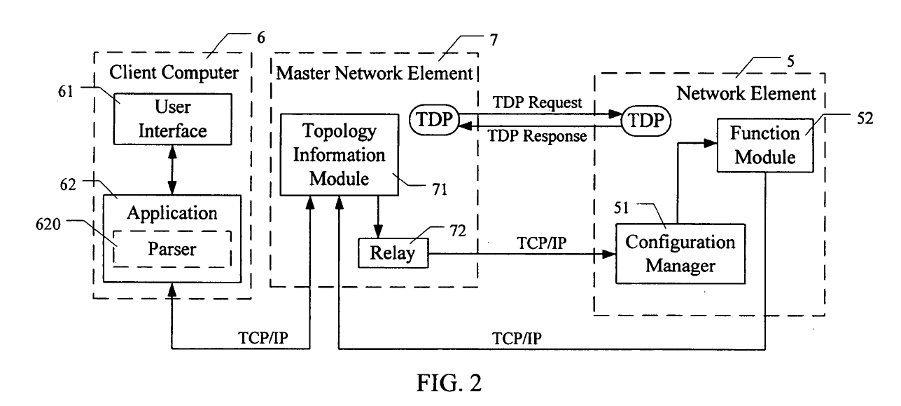

FIG. 2 is a schematic diagram of a software infrastructure of the integrated network element management system of the present invention. The client computer 6 comprises the user interface 61 and an application 62. The application 62 includes a parser 620. The master network element 7 comprises a topology information module 71 and a relay 72. The topology information module 71 stores information on the topology of the network 4, and configuration files of the network elements 5. In the preferred embodiment, the network manager may send the request for the topology of the network 4 to the master network element 7 using Transmission Control Protocol/Internet Protocol (TCP/IP). Then the master network element 7 sends the response including information on the topology in extensible markup language (XML) format to the client computer 6 using TCP/IP. After the client computer 6 receives the information on the topology in XML format, the parser 620 parses the XML format information, and the topology of the network 4 is displayed on the user interface 61.

The master network element 7 communicates with the network elements 5 using TDP. At regular predetermined time intervals, such as every 0.1 seconds, the master network element 7 sends a TDP request to all the network elements 5. After receiving the TDP request, each network element 5 sends a response to the master network element 7. Each response comprises topology information collected by the corresponding network element 5. The TDP request and the TDP response are transmitted using TCP/IP.

In the preferred embodiment, TCP/IP protocol is employed for transmitting relevant information. In alternative embodiments, other protocols, such as Hypertext Transfer Protocol (HTTP) or File Transfer Protocol (FTP), can be employed to transmit information.

The application 62 is provided for performing configuration of a network element 5 selected by the network manager. The selection is made using the topology displayed on the user interface 61. When the network element 5 is selected, the configuration file of the network element 5 is transmitted from the topology information module 71 to the application 62. Under the control of the network manager, the application 62 performs configuration of the network element 5. Then the configuration file of the network element 5, which comprises the configuration results, is stored in the topology information module 71. In the preferred embodiment, the configuration file is in XML format.

When the icon of the configured network element 5 is dragged to icons of other network elements 5 that have not been configured, the topology information module 71 transmits the configuration file of the configured network element 5 to configuration files of said other network elements 5. After receiving the configuration file of the configured network element 5, a configuration manager 51 in each network element 5 translates the configuration file into configuration demands that can be executed by the network element 5. A function module 52 in the network element 5 automatically performs configuration according to the configuration demands.

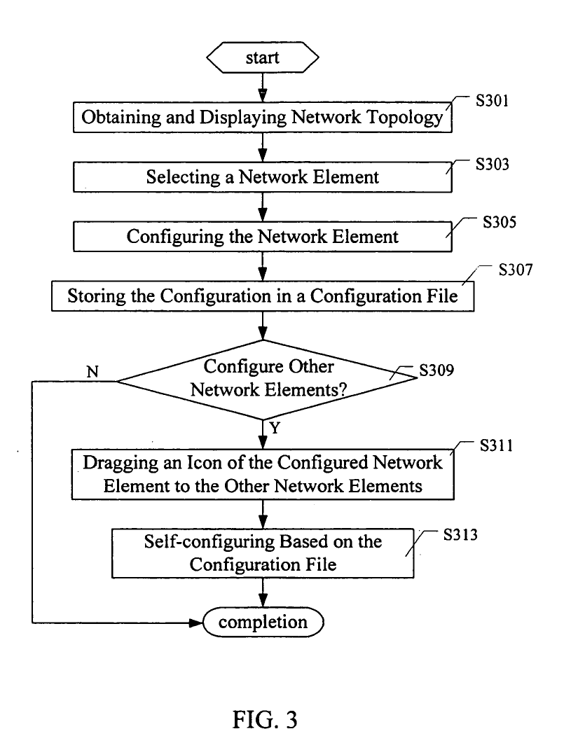

FIG. 3 is a flow chart of an integrated network element management method in accordance with the preferred embodiment of the present invention. At step S301, the network manager sends a request for information on the current topology of the network 4 through the user interface 61. After obtaining the information, the user interface 61 displays the topology of the network 4. At step S303, the network manager selects a network element 5 in the topology through the user interface 61. At step S305, the network manager configures the selected network element 5 by using the client computer 6. After finishing the configuration, at step S307, the application 62 of the client computer 6 stores the configuration in the configuration file of the selected network element 5. At step S309, the network manager determines whether other network elements 5 need to be configured. If no other network element 5 needs to be configured, the procedure is completed. Otherwise, at step S311, the network manager drags the icon representing the configured network element 5 to icons representing other network elements 5 that need to be configured. Accordingly, the configuration file of the configured network element 5 is transmitted to said other network elements 5. At step S313, the other network elements 5 self-configure based on the configuration file of the configured network element 5.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

1. An integrated network element management system for configuring various network elements on a network, the system comprising:
a client computer, comprising:
a user interface for displaying a topology of the network, each network element being displayed in the topology in the form of an icon, and each icon being draggable using a computer mouse; and
an application for performing configurations on the network elements; and
a master network element communicatively connecting to the client computer and the network elements, and communicating with the network elements via an element discovery mechanism for obtaining information on the topology of the network, the master network element comprising a topology information module for collecting and storing the information on the topology of the network, and for storing configuration files of the network elements;
whereby, when an icon representing one network element is dragged to icons representing other network elements, a configuration file of said one network element is transmitted to said other network elements.

2. The integrated network element management system as recited in claim 1, wherein the information on the topology is in extensible markup language (XML) format.

3. The integrated network element management system as recited in claim 2, wherein the application comprises a parser for parsing the XML format information and displaying parsed information on the user interface.

4. The integrated network element management system as recited in claim 1, wherein the element discovery mechanism is topology discovery protocol.

5. The integrated network element management system as recited in claim 1, wherein the element discovery mechanism is Network Neighborhood of the Windows Operating System.

6. An integrated network element management method for configuring various network elements on a network, the method comprising the steps of:
(a) obtaining a topology of the network, and displaying the topology on a user interface, the network elements being represented with icons in the topology;
(b) selecting a specific network element from the topology on the user interface, and configuring the specific network;
(c) storing configuration results in a configuration file of the specific network;
(d) determining whether there is another network element needing to be configured;
(e) if there is another network element needing to be configured, dragging the icon of the specific network element to the icon of the another network element, whereby the configuration file of the specific network element is transmitted to said another network element; and
(f) said another network element automatically self-configuring based on the configuration file of the specific network element.

7. The integrated network element management method as recited in claim 6, wherein step (f) comprises the step of:
translating the configuration file of the specific network element into executable demands.

8. An integrated network element management system for configuring various network elements on a network, the system comprising:
a user interface for displaying a topology of the network, each network element being displayed in the topology in the form of an icon, and each icon being draggable using a computer mouse;
an application for performing configurations on a network element that is selected from the topology;
a topology information module communicatively connecting to the client computer and the network elements, and communicating with the network elements via an element discovery mechanism for obtaining information on the topology of the network, and for storing configuration files of the network elements;
whereby, when an icon representing a specific network element that has been configured is dragged to icons representing other network elements, a configuration file of the specific network element is transmitted to said other network elements;
a configuration manager in each network element for receiving the configuration file of the specific network that has been configured, and for translating the configuration file into executable demands; and
a function module in each network element for performing configurations on the network element to which the function module pertains, according to the executable demands.
